(19) United States
(12) Patent Application Publication
(10) Pub. No.: US 2013/0174562 A1
(43) Pub. Date: Jul. 11, 2013

(54) GAS TURBINE ENGINE, COMBUSTOR AND DOME PANEL

(71) Applicants: Marcus Timothy Holcomb, Carmel, IN (US); Todd Taylor, Whiteland, IN (US)

(72) Inventors: Marcus Timothy Holcomb, Carmel, IN (US); Todd Taylor, Whiteland, IN (US)

(21) Appl. No.: 13/348,151

(22) Filed: Jan. 11, 2012

(51) Int. Cl. F02C 7/00

(52) U.S. Cl. 60/752

(57) ABSTRACT

One embodiment of the present invention is a unique dome panel for a gas turbine engine combustor. Another embodiment is a unique gas turbine combustor. Yet another embodiment is a unique gas turbine engine. Other embodiments include apparatuses, systems, devices, hardware, methods, and combinations for gas turbine engines and combustion systems and components. Further embodiments, forms, features, aspects, benefits, and advantages of the present application will become apparent from the description and figures provided herewith.

### GOVERNMENT RIGHTS

The present application was made with the United States government support under Contract No. FA8650-07-C-2803, awarded by the United States Air Force. The United States government may have certain rights in the present application.

### FIELD OF THE INVENTION

The present invention relates to gas turbine engines, and more particularly, to combustors and dome panels for gas turbine engines.

### BACKGROUND

Gas turbine engine combustors and dome panels for combustors remain an area of interest. Some existing systems have various shortcomings, drawbacks, and disadvantages relative to certain applications. Accordingly, there remains a need for further contributions in this area of technology.

### SUMMARY

One embodiment of the present invention is a unique dome panel for a gas turbine engine combustor. Another embodiment is a unique gas turbine combustor. Yet another embodiment is a unique gas turbine engine. Other embodiments include apparatuses, systems, devices, hardware, methods, and combinations for gas turbine engines and combustion systems and components. Further embodiments, forms, features, aspects, benefits, and advantages of the present application will become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 schematically illustrates some aspects of a non-limiting example of a gas turbine engine in accordance with an embodiment of the present invention.

FIG. 2 schematically illustrates some aspects of a non-limiting example of a gas turbine engine combustor in accordance with an embodiment of the present invention.

FIG. 3 schematically illustrates some aspects of the gas turbine engine combustor of FIG. 2.

FIGS. 4A-4C illustrate some aspects of a non-limiting example of a dome panel for a combustor of a gas turbine engine in accordance with an embodiment of the present invention.

### DETAILED DESCRIPTION

For purposes of promoting an understanding of the principles of the invention, reference will now be made to the embodiments illustrated in the drawings, and specific language will be used to describe the same. It will nonetheless be understood that no limitation of the scope of the invention is intended by the illustration and description of certain embodiments of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

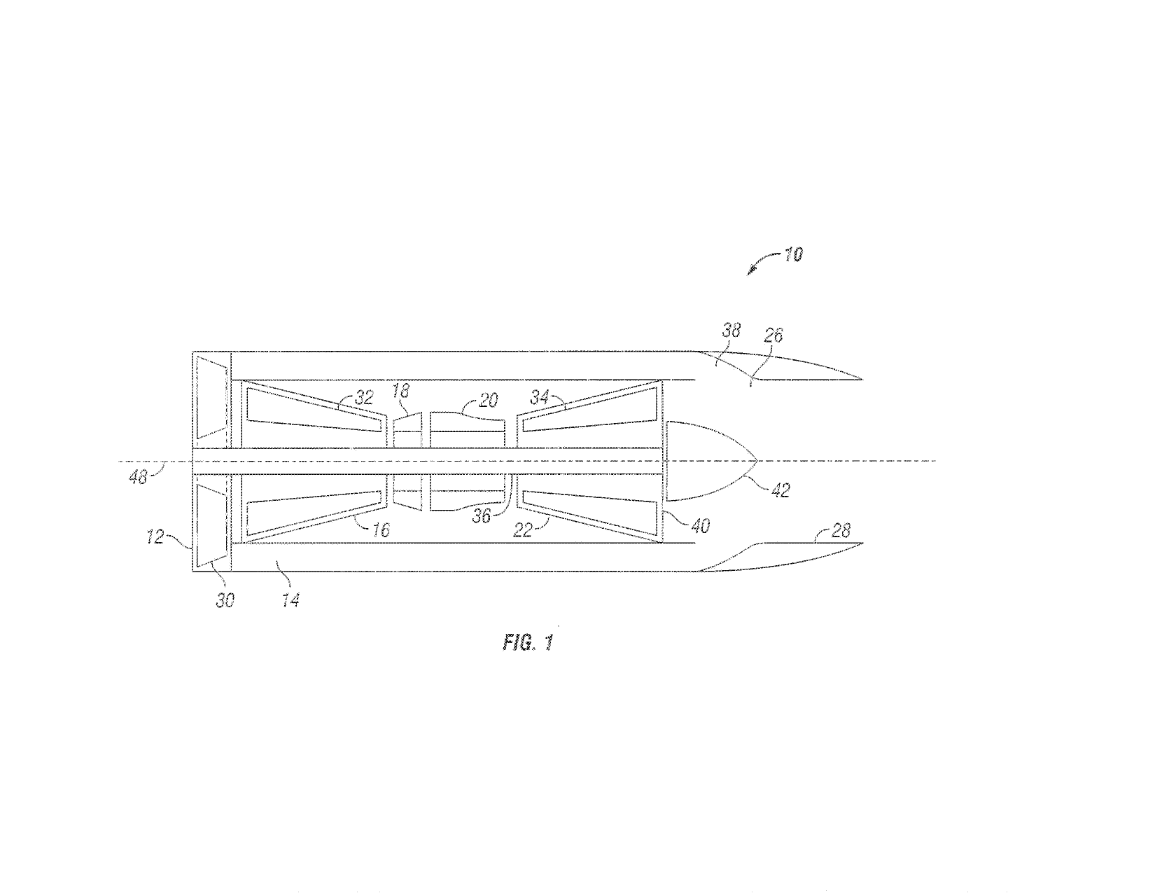

Referring to the drawings, and in particular FIG. 1, a non-limiting example of some aspects of a gas turbine engine 10 in accordance with an embodiment of the present invention is schematically depicted. In one form, gas turbine engine 10 is an aircraft propulsion power plant. In other embodiments, gas turbine engine 10 may be a land-based or marine engine. In one form, gas turbine engine 10 is a multi-spool turbofan engine. In other embodiments, gas turbine engine 10 may take other forms, and may be, for example, a turboshaft engine, a turbojet engine, a turboprop engine, or a combined cycle engine having a single spool or multiple spools.

As a turbofan engine, gas turbine engine 10 includes a fan 12, a bypass duct 14, a compressor 16, a diffuser 18, a combustor 20, a turbine 22, a discharge duct 26 and a nozzle system 28. Bypass duct 14 and compressor 16 are in fluid communication with fan system 12. Diffuser 18 is in fluid communication with compressor 16. Combustor 20 is fluidly disposed between compressor 16 and turbine 22. In one form, combustor 20 includes an annular combustion liner (not shown in FIG. 1) that contains a continuous combustion process. In other embodiments, combustor 20 may take other forms, and may be, for example and without limitation, a can combustor or a canannular combustor.

Fan 12 includes a fan rotor system 30. In various embodiments, fan rotor system 30 includes one or more rotors (not shown) that are powered by turbine 22. Bypass duct 14 is operative to transmit a bypass flow generated by fan system 12 to nozzle 28. Compressor 16 includes a compressor rotor system 32. In various embodiments, compressor rotor system 32 includes one or more rotors (not shown) that are powered by turbine 22. Each compressor rotor includes a plurality of rows compressor blades (not shown) that are alternatingly interspersed with rows of compressor vanes (not shown). Turbine 22 includes a turbine rotor system 34. In various embodiments, turbine rotor system 34 includes one or more rotors (not shown) operative to drive fan rotor system 30 and compressor rotor system 32. Each turbine rotor includes a plurality of turbine blades (not shown) that are alternatingly interspersed with rows of turbine vanes (not shown).

Turbine rotor system 34 is drivingly coupled to compressor rotor system 32 and fan rotor system 30 via a shafting system 36. In various embodiments, shafting system 36 includes a plurality of shafts that may rotate at the same or different speeds and directions. In some embodiments, only a single shaft may be employed. Turbine 22 is operative to discharge an engine 10 core flow to nozzle 28.

In one form, fan rotor system 30, compressor rotor system 32, turbine rotor system 34 and shafting system 36 rotate about an engine centerline 48. In other embodiments, all or parts of fan rotor system 30, compressor rotor system 32, turbine rotor system 34 and shafting system 36 may rotate about one or more other axes of rotation in addition to or in place of engine centerline 48.

Discharge duct 26 extends between a discharge portion 40 of turbine 22 and engine nozzle 28. Discharge duct 26 is operative to direct bypass flow and core flow from a bypass duct discharge portion 38 and turbine discharge portion 40, respectively, into nozzle 28. In some embodiments, discharge duct 26 may be considered a part of nozzle 28. Nozzle 28 is in fluid communication with fan system 12 and turbine 22. Nozzle 28 is operative to receive the bypass flow from., fan system 12 via bypass duct 14, and to receive the core flow from turbine 22, and to discharge both as an engine exhaust flow, e.g., a thrust-producing flow. In other embodiments, other nozzle arrangements may be employed, including separate nozzles for each of the core flow and the bypass flow.

During the operation of gas turbine engine 10, air is drawn into the inlet of fan 12 and pressurized by fan 12. Some of the air pressurized by fan 12 is directed into compressor 16 as core flow, and some of the pressurized air is directed into bypass duct 14 as bypass flow, which is discharged into nozzle 28 via discharge duct 26. Compressor 16 further pressurizes the portion of the air received therein from fan 12, which is then discharged into diffuser 18. Diffuser 18 reduces the velocity of the pressurized air, and directs the diffused core airflow into combustor 20. Fuel is mixed with the pressurized air in combustor 20, which is then combusted. The hot gases exiting combustor 20 are directed into turbine 22, which extracts energy in the form of mechanical shaft power sufficient to drive fan 12 and compressor 16 via shafting system 36. The core flow exiting turbine 22 is directed along an engine tail cone 42 and into discharge duct 26, along with the bypass flow from bypass duct 14. Discharge duct 26 is configured to receive the bypass flow and the core flow, and to discharge both into nozzle 28 as an engine exhaust flow, e.g., for providing thrust, such as for aircraft propulsion.

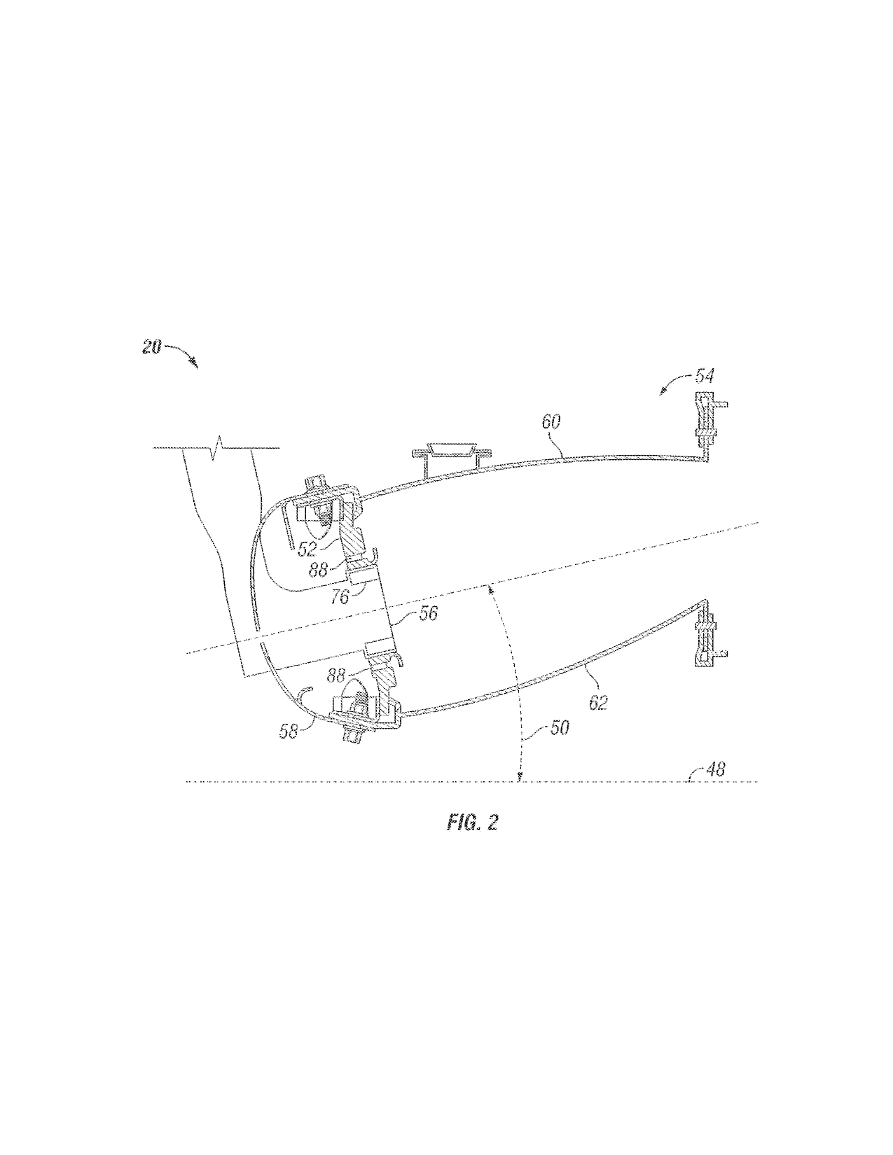

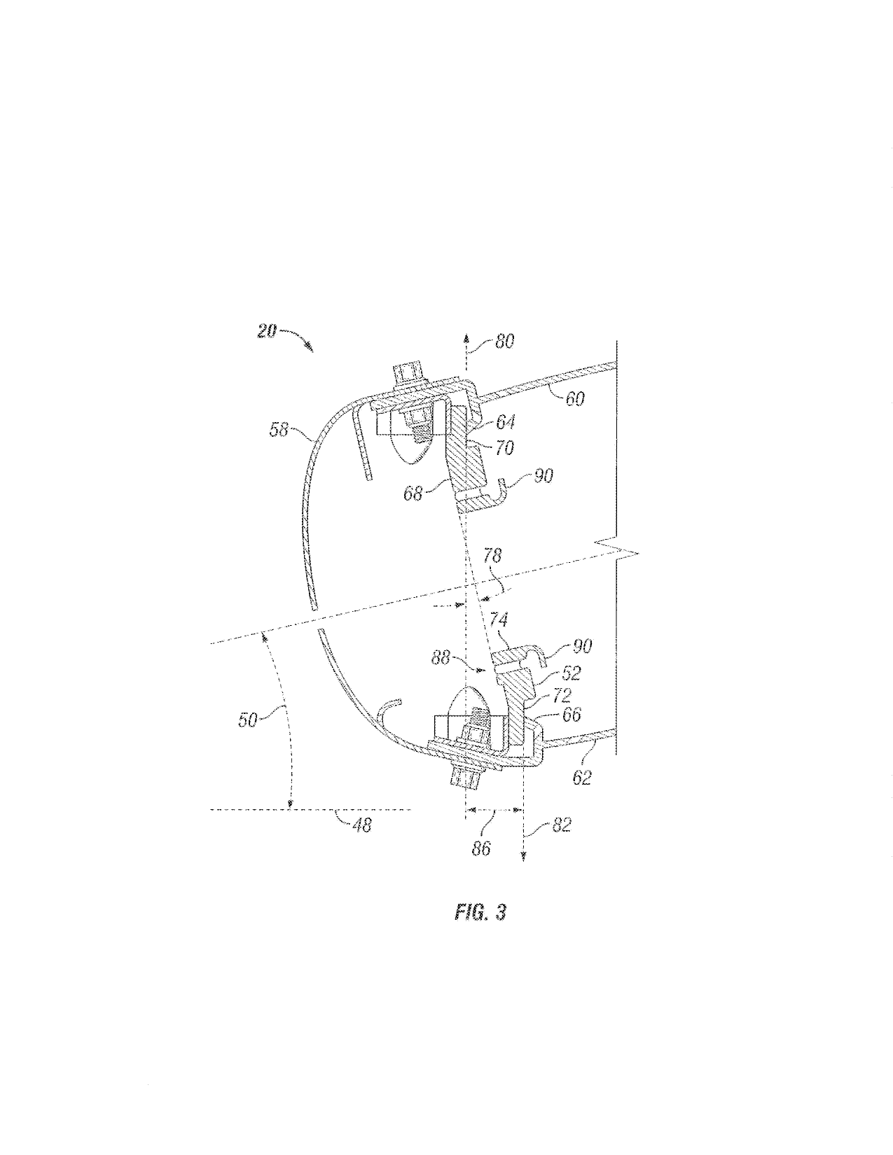

Referring now to FIGS. 2 and 3, combustor 20 is a canted combustor, which is canted at a cant angle 50 relative to engine centerline 48. Canted combustor 20 includes a plurality of dome panels 52, a combustion liner 54, a plurality of fuel nozzles 56, and a heat shield 58. Fuel nozzle 56 is not shown in FIG. 3 for purposes of clarity of illustration. Dome panels 52 are disposed circumferentially around the forward end of combustion liner 54. In one form, combustion liner 54 is an annular combustion liner. In other embodiments, combustion liner 54 may take other forms. Combustion liner 54 includes an outer combustion liner 60 and an inner combustion liner 62. Outer combustion liner 60 includes a mating surface 64 configured for engagement with each dome panel 52. Inner combustion liner 62 includes a mating surface 66 configured for engagement with each dome panel 52.

Each dome panel 52 includes a central portion 68, an upper contact surface 70 and a lower contact surface 72. Central portion 68 includes an opening 74 configured to receive at least one of a fuel nozzle 56 and a swirler 76. In other embodiments, more than one opening 74 may be disposed in dome panel 52 for receiving one or more additional fuel nozzles 56 and/or swirlers 76 and/or one or more other components. In one form, swirler 76 is considered a part of fuel nozzle 56. In other embodiments, swirler 76 may be separate from fuel nozzle 56. In still other embodiments, combustor 20 may not include a swirler disposed within opening 74. Opening 74 is canted at cant angle 50, which orients fuel nozzle 56 at cant angle 50. In one form, central portion 68 is canted at an angle 78 perpendicular to cant angle 50. In other embodiments, central portion 68 may be canted at one or more other angles, or may not be canted.

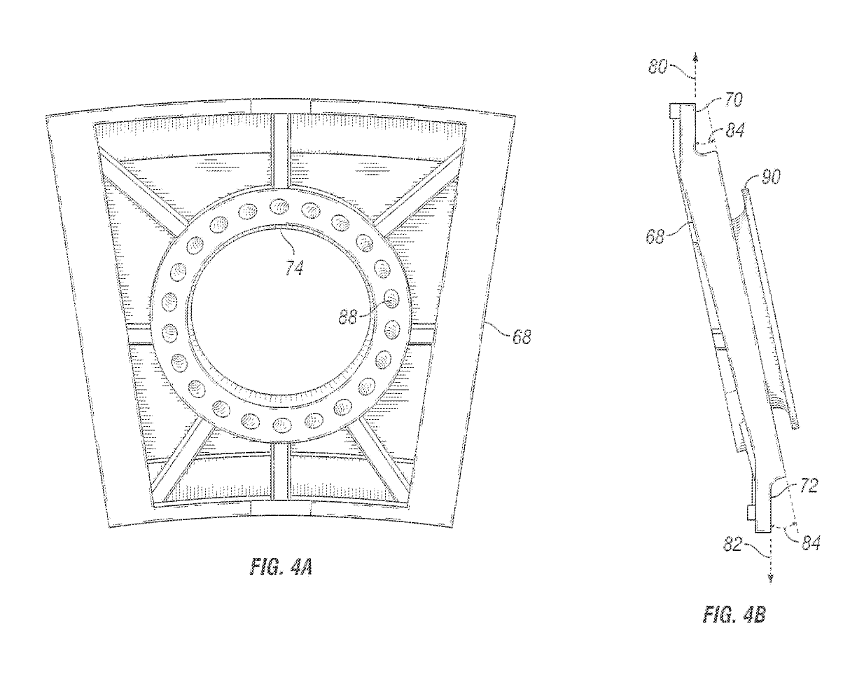

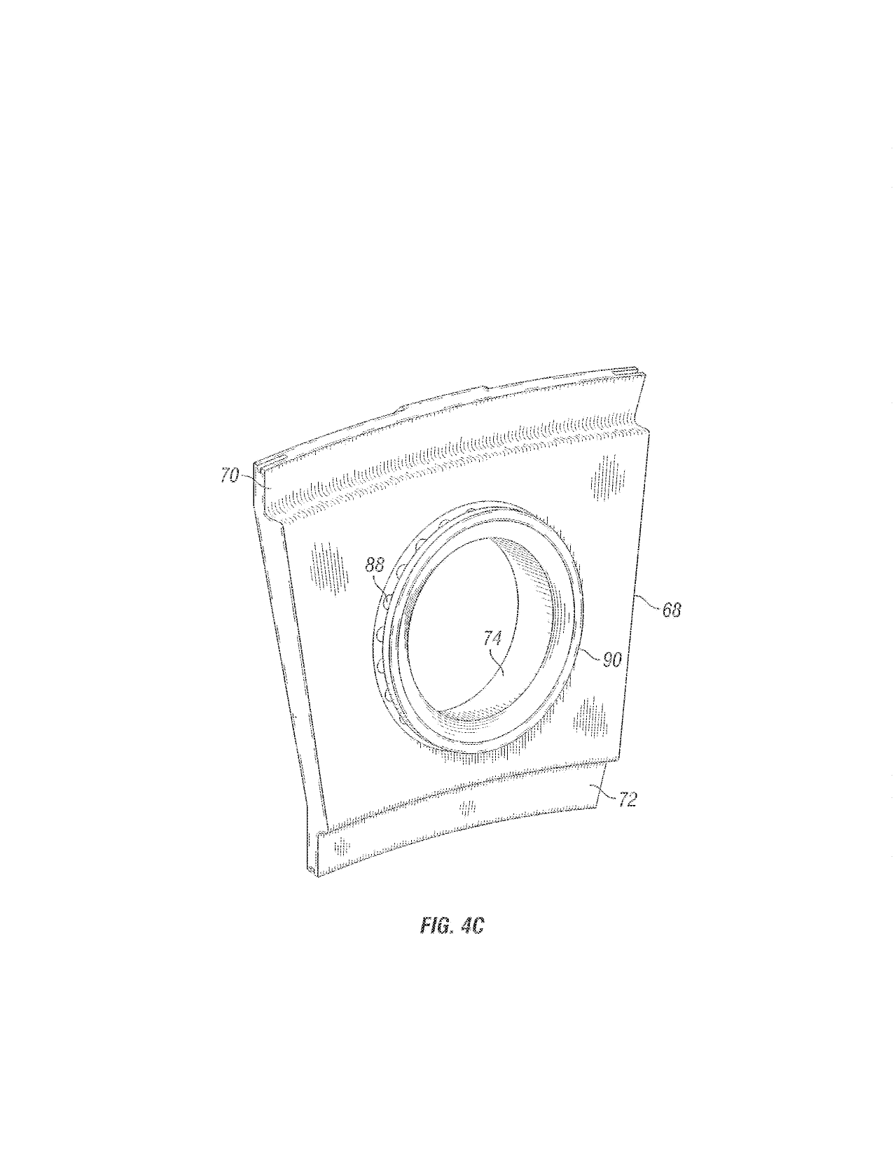

Referring to FIGS. 4A-4C, in conjunction with FIGS. 2 and 3, upper contact surface 70 extends radially outward from central portion 68 in a radial direction 80 perpendicular to centerline 48 of engine 10. Lower contact surface 72 extends radially inward from central portion 68 in a radial direction 82 perpendicular to centerline 48 of engine 10. In one form, central portion 68 is oriented at an angle 84 relative to upper contact surface 70 and lower contact surface 72. In one form, angle 84 is the same in magnitude as cant angle 50. In other embodiments, central portion 68 may be oriented differently.

Upper contact surface 70 is spaced apart from lower contact surface 72 in an axial direction 86 that is parallel to centerline 48 of engine 10. Upper contact surface 70 is configured for sliding engagement with mating surface 64 of outer combustion liner 60 in directions 80 and 82. Lower contact surface 72 is configured for sliding engagement with mating surface 66 of inner combustion liner 62 in directions 80 and 82. Combustion liner 54 and dome panels 52 are thus configured for sliding engagement in directions 80 and 82 perpendicular to centerline 48 of engine 10. In one form, upper contact surface 70, lower contact surface 72, mating surface 64 and mating surface 66 are planar, each having a plane that is perpendicular to centerline of 48 of engine 10. In other embodiments, one or more of upper contact surface 70, lower contact surface 72, mating surface 64 and mating surface 66 may not be planar. The use of at least two planar surfaces, in conjunction with the orientation of at least two planar surfaces in a radial direction permits relative motion between combustion liner 54 and dome panels 52 in radial directions 80 and 82 perpendicular to centerline 48, which may maintain combustor 20 integrity while undergoing the temperature gradients typically encountered during engine 10 operation.

In order to aid in mixing fuel and air, and to provide cooling to combustion liner 54, some embodiments of dome panels 52 include a swirler defined by a plurality of angled openings 88 in central portion 68. In some embodiments, dome panels 52 also include a deflector 90, which deflects the air swirled by openings 88 radially outward toward outer combustion liner 60 and inner combustion liner 62 for cooling outer combustion liner 60 and inner combustion liner 62, as well as along central portion 68 for cooling of dome panels 52.

Embodiments of the present invention include a combustor dome panel for a canted combustor of a gas turbine engine, a central portion; an upper contact surface extending radially outward from the central portion in a direction perpendicular to a centerline of the gas turbine engine, wherein the upper contact surface is configured to engage a first mating surface of an outer combustion liner of the canted combustor; and a lower contact surface extending radially inward from the central portion in a direction perpendicular to the centerline of the gas turbine engine, wherein the lower contact surface is configured to engage a second mating surface of an inner combustion liner of the canted combustor.

In a refinement, the central portion includes an opening configured to receive at least one of a fuel nozzle and a swirler.

In another refinement, the opening is canted at a cant angle of the canted combustor.

In yet another refinement, the central portion is canted at an angle perpendicular to a cant angle of the canted combustor.

In still another refinement, the central portion is oriented at an angle relative to the upper contact surface and the lower contact surface that is the same as a cant angle of the canted combustor.

In yet still another refinement, the upper contact surface is spaced apart from the lower contact surface in an axial direction parallel to the centerline of the gas turbine engine.

In a further refinement, the upper contact surface is planar and wherein the lower contact surface is planar.

Embodiments of the present invention include a canted combustor for a gas turbine engine, comprising: a combustion liner canted at a cant angle relative to a centerline of the gas turbine engine; and a plurality of dome panels configured for mating engagement with the combustion liner, wherein the combustion liner and the plurality of dome panels are configured for sliding engagement in a direction perpendicular to the centerline of the gas turbine engine.

In a refinement, the sliding engagement is configured to yield relative motion between the combustion liner and the dome panels in a radial direction perpendicular to the centerline of the gas turbine engine.

In another refinement, at least one dome panel includes an upper contact surface extending radially outward in a direction perpendicular to a centerline of the gas turbine engine; wherein the upper contact surface is configured to engage the combustion liner; wherein the at least one dome panel includes a lower contact surface extending radially inward in a direction perpendicular to the centerline of the gas turbine engine; and wherein the lower contact surface is configured to engage the combustion liner.

In yet another refinement, the combustion liner includes: an outer combustion liner having a first mating surface configured to engage each dome panel; and an inner combustion liner having a second mating surface also configured to engage each dome panel.

In still another refinement, the upper contact surface is configured to engage the first mating surface; and wherein the lower contact surface is configured to engage the second mating surface.

In yet still another refinement, at least one of the upper contact surface and the first mating surface is planar, having a plane perpendicular to the centerline of the gas turbine engine; and wherein at least one of the lower contact surface and the second mating surface is planar, having a plane perpendicular to the centerline of the gas turbine engine.

In a further refinement, the at least one dome panel includes a canted central portion; wherein the upper contact surface extends radially outward from the canted central portion; and wherein the lower contact surface extends radially inward from the canted central portion.

In a yet further refinement, the canted central portion is canted at an angle perpendicular to the cant angle of the canted combustor.

In a still further refinement, the canted central portion is oriented at an angle relative to the upper contact surface and the lower contact surface that is the same as the cant angle of the canted combustor.

Embodiments of the present invention include a gas turbine engine, comprising: a compressor; a canted combustor in fluid communication with the compressor; and a turbine in fluid communication with the canted combustor, wherein the canted combustor includes a combustion liner and a plurality of dome panels; and wherein the combustion liner and the dome panels are configured for sliding engagement with each other in a direction perpendicular to a centerline of the gas turbine engine.

In a refinement, at least one dome panel includes: a central portion; an upper contact surface extending radially outward from the central portion in a direction perpendicular to the centerline of the gas turbine engine, wherein the upper contact surface is configured to engage the combustion liner; and a lower contact surface extending radially inward from the central portion in a direction perpendicular to the centerline of the gas turbine engine, wherein the lower contact surface is configured to engage the combustion liner.

In another refinement, the canted combustor is canted at a cant angle relative to the centerline of the gas turbine engine; and wherein the central portion is canted at the cant angle of the canted combustor relative to the upper contact surface and the lower contact surface.

In yet another refinement, the canted combustor is canted at a cant angle relative to the centerline of the gas turbine engine; wherein the central portion includes an opening configured to receive at least one of a fuel nozzle and a swirler; and wherein the opening is canted at the cant angle of the canted combustor.

In still another refinement, the canted combustor includes a combustion liner; wherein the combustion liner includes a first mating surface configured to engage the upper contact surface of each dome panel; wherein the combustion liner includes a second mating surface configured to engage the lower contact surface of each dome panel; and wherein the first mating surface is axially offset from the second mating surface.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A combustor dome panel for a canted combustor of a gas turbine engine, comprising:
a central portion;
an upper contact surface extending radially outward from the central portion in a direction perpendicular to a centerline of the gas turbine engine, wherein the upper contact surface is configured to engage a first mating surface of an outer combustion liner of the canted combustor; and
a lower contact surface extending radially inward from the central portion in a direction perpendicular to the centerline of the gas turbine engine, wherein the lower contact surface is configured to engage a second mating surface of an inner combustion liner of the canted combustor.

2. The combustor dome panel of claim 1, wherein the central portion includes an opening configured to receive at least one of a fuel nozzle and a swirler.

3. The combustor dome panel of claim 2, wherein the opening is canted at a cant angle of the canted combustor.

4. The combustor dome panel of claim 1, wherein the central portion is canted at an angle perpendicular to a cant angle of the canted combustor.

5. The combustor dome panel of claim 1, wherein the central portion is oriented at an angle relative to the upper contact surface and the lower contact surface that is the same as a cant angle of the canted combustor.

6. The combustor dome panel of claim 1, wherein the upper contact surface is spaced apart from the lower contact surface in an axial direction parallel to the centerline of the gas turbine engine.

7. The combustor dome panel of claim 1, wherein the upper contact surface is planar and wherein the lower contact surface is planar.

8. A canted combustor for a gas turbine engine, comprising:
a combustion liner canted at a cant angle relative to a centerline of the gas turbine engine; and
a plurality of dome panels configured for mating engagement with the combustion liner,
wherein the combustion liner and the plurality of dome panels are configured for sliding engagement in a direction perpendicular to the centerline of the gas turbine engine.

9. The canted combustor of claim 8, wherein the sliding engagement is configured to yield relative motion between the combustion liner and the dome panels in a radial direction perpendicular to the centerline of the gas turbine engine.

10. The canted combustor of claim 8, wherein at least one dome panel includes an upper contact surface extending radially outward in a direction perpendicular to a centerline of the gas turbine engine; wherein the upper contact surface is configured to engage the combustion liner; wherein the at least one dome panel includes a lower contact surface extending radially inward in a direction perpendicular to the centerline of the gas turbine engine; and wherein the lower contact surface is configured to engage the combustion liner.

11. The canted combustor of claim 10, wherein the combustion liner includes: an outer combustion liner having a first mating surface configured to engage each dome panel; and an inner combustion liner having a second mating surface also configured to engage each dome panel.

12. The canted combustor of claim 11, wherein the upper contact surface is configured to engage the first mating surface; and wherein the lower contact surface is configured to engage the second mating surface.

13. The canted combustor of claim 12, wherein at least one of the upper contact surface and the first mating surface is planar, having a plane perpendicular to the centerline of the gas turbine engine; and wherein at least one of the lower contact surface and the second mating surface is planar, having a plane perpendicular to the centerline of the gas turbine engine.

14. The canted combustor of claim 10, wherein the at least one dome panel includes a canted central portion; wherein the upper contact surface extends radially outward from the canted central portion; and wherein the lower contact surface extends radially inward from the canted central portion.

15. The canted combustor of claim 14, wherein the canted central portion is canted at an angle perpendicular to the cant angle of the canted combustor.

16. The canted combustor of claim 14, wherein the canted central portion is oriented at an angle relative to the upper contact surface and the lower contact surface that is the same as the cant angle of the canted combustor.

17. A gas turbine engine, comprising:
a compressor;
a canted combustor in fluid communication with the compressor; and
a turbine in fluid communication with the canted combustor,
wherein the canted combustor includes a combustion liner and a plurality of dome panels; and wherein the combustion liner and the dome panels are configured for sliding engagement with each other in a direction perpendicular to a centerline of the gas turbine engine.

18. The gas turbine engine of claim 17, wherein at least one dome panel includes:
a central portion;
an upper contact surface extending radially outward from the central portion in a direction perpendicular to the centerline of the gas turbine engine, wherein the upper contact surface is configured to engage the combustion liner; and
a lower contact surface extending radially inward from the central portion in a direction perpendicular to the centerline of the gas turbine engine, wherein the lower contact surface is configured to engage the combustion liner.

19. The gas turbine engine of claim 18, wherein the canted combustor is canted at a cant angle relative to the centerline of the gas turbine engine; and wherein the central portion is canted at the cant angle of the canted combustor relative to the upper contact surface and the lower contact surface.

20. The gas turbine engine of claim 18, wherein the canted combustor is canted at a cant angle relative to the centerline of the gas turbine engine; wherein the central portion includes an opening configured to receive at least one of a fuel nozzle and a swirler; and wherein the opening is canted at the cant angle of the canted combustor.

21. The gas turbine engine of claim 18, wherein the canted combustor includes a combustion liner; wherein the combustion liner includes a first mating surface configured to engage the upper contact surface of each dome panel; wherein the combustion liner includes a second mating surface configured to engage the lower contact surface of each dome panel; and wherein the first mating surface is axially offset from the second mating surface.
